(19) United States
(12) Patent Application Publication
(10) Pub. No.: US 2023/0419736 A1
(43) Pub. Date: Dec. 28, 2023

(54) DETECTION APPARATUS AND SPOOFING DETECTION METHOD

(71) Applicant: Fujitsu Limited, Kawasaki-shi (JP)

(72) Inventors: Atsuya SUZUKI, Kawasaki (JP); Jun TAKAHASHI, Kawasaki (JP); Toshiyuki YOSHITAKE, Kawasaki (JP); Masayoshi SHIMIZU, Hadano (JP)

(73) Assignee: Fujitsu Limited, Kawasaki-shi (JP)

(21) Appl. No.: 18/297,669

(22) Filed: Apr. 10, 2023

(30) Foreign Application Priority Data
Jun. 24, 2022 (JP) 2022-101961

(51) Int. Cl. G06V 40/40; G06V 40/20; G06V 10/44

(52) U.S. Cl. CPC G06V 40/40; G06V 40/20; G06V 10/44; G06V 2201/07

(57) ABSTRACT

A non-transitory computer-readable recording medium stores a program for causing a computer to execute a process, the process includes acquiring an image data group in which a target person appears from a storage unit, identifying a first behavior of the target person, of which a frequency of appearance is lower than a frequency of appearance of a second behavior by using the acquired image data group, and when it is detected that image data, in which the target person appears and which is displayed on a screen, has a suspicion of spoofing, outputting a message prompting the target person appearing in image data to take the identified first behavior.

### CROSS-REFERENCE TO RELATED APPLICATION

This application is based upon and claims the benefit of priority of the prior Japanese Patent Application No. 2022-101961, filed on Jun. 24, 2022, the entire contents of which are incorporated herein by reference.

### FIELD

The embodiment discussed herein is related to a detection apparatus and a spoofing detection method.

### BACKGROUND

In recent years, abuse of a synthesis photograph or moving image (deepfake) generated by using a deep learning method of artificial intelligence has become a problem. A synthesis medium including such a synthesis photograph or moving image has very high quality due to a synthesis technique of a medium by deep learning, and it is difficult to recognize the synthesis medium as a fake image at a glance.

For recognizing such a fake image, for example, a technique of determining whether or not a person in an image is the person himself or herself based on a degree of matching of a result obtained by comparing a certain pose obtained from past data with a certain current pose is disclosed.

Japanese Laid-open Patent Publication No. 2007-148724 and Japanese Laid-open Patent Publication No. 2001-318892 are disclosed as related art.

### SUMMARY

According to an aspect of the embodiment, a non-transitory computer-readable recording medium stores a program for causing a computer to execute a process, the process includes acquiring an image data group in which a target person appears from a storage unit, identifying a first behavior of the target person, of which a frequency of appearance is lower than a frequency of appearance of a second behavior by using the acquired image data group, and when it is detected that image data, in which the target person appears and which is displayed on a screen, has a suspicion of spoofing, outputting a message prompting the target person appearing in image data to take the identified first behavior.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating an example of a configuration of a system including a detection apparatus according to an embodiment;

FIG. 2 is a diagram illustrating an example of a functional configuration of the detection apparatus according to the embodiment;

FIG. 3A is a diagram (1) illustrating an example of a flow of identifying a feature value according to the embodiment;

FIG. 3B is a diagram (2) illustrating an example of the flow of identifying the feature value according to the embodiment;

FIG. 4A is an image diagram (1) of presentation according to the embodiment;

FIG. 4B is an image diagram (2) of presentation according to the embodiment;

FIG. 4C is an image diagram (3) of presentation according to the embodiment;

FIG. 5 is a diagram illustrating an example of an application of spoofing detection according to the embodiment;

FIG. 6 is a diagram illustrating an example of a flowchart of the entire spoofing detection according to the embodiment;

FIG. 7 is a diagram illustrating an example of a flowchart of spoofing detection processing according to the embodiment; and

FIG. 8 is a diagram illustrating an example of a computer that executes a spoofing detection program.

### DESCRIPTION OF EMBODIMENT

There is a problem that it is difficult to detect spoofing by deepfake.

For example, past photographic data or the like is used in both the generation of the fake image and the spoofing detection technique of recognizing the fake image. The past photographic data and the like are acquired, in recent years, via a social networking service (SNS), the Internet, or the like. A photograph used to generate the fake image and a photograph used in the spoofing detection technique may be substantially the same. In such a case, the spoofing detection technique may determine that the fake image is the person himself or herself. Accordingly, it is difficult for the spoofing detection technique to detect the spoofing by the deepfake.

Hereinafter, an embodiment of a detection apparatus and a spoofing detection method disclosed in the present application will be described in detail with reference to the drawings. The present disclosure is not limited by the embodiment.

### Embodiment

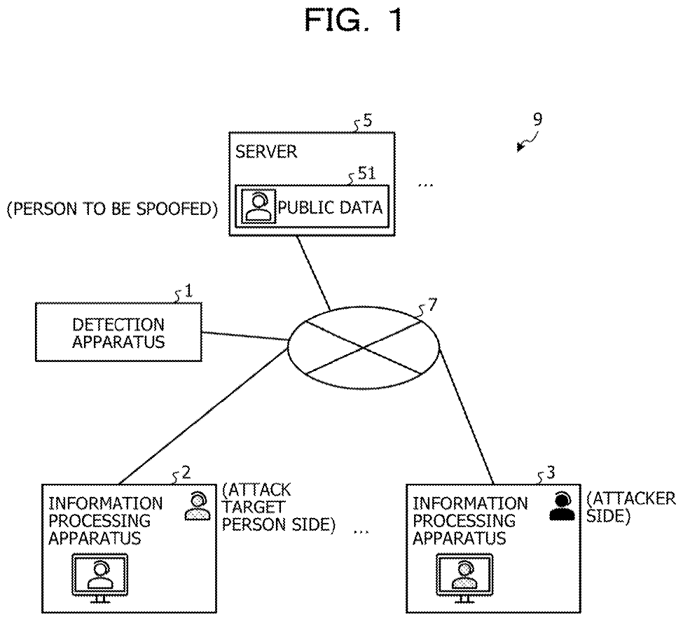

FIG. 1 is a functional block diagram illustrating an example of a configuration of a system including a detection apparatus according to an embodiment. A system 9 according to the embodiment extracts an image with a reduced quality against spoofing that is made by a moving image (deepfake) generated by using a deep learning method of artificial intelligence, and improves accuracy of spoofing detection.

The system 9 includes a detection apparatus 1, information processing apparatuses 2 and 3, and a server 5. The detection apparatus 1, the information processing apparatuses 2 and 3, and the server 5 are coupled to each other via a network 7. Users of the information processing apparatus 2 and the information processing apparatus 3 perform a teleconference while viewing moving image data of each other via the detection apparatus 1. The information processing apparatus 3 is an apparatus on an attacker side that performs spoofing by the deepfake. The information processing apparatus 2 is an apparatus on a side to be deceived, for example, an attack target person side. Although one information processing apparatus 2 is provided on the attack target person side, a plurality of information processing apparatuses 2 may be provided.

The server 5 manages public data 51. The public data 51 is an image data group including a past image data group in which a target person to be spoofed appears, and is an image data group that is made public. The image data group includes moving image data and still image data. Some moving image data includes audio data. A plurality of servers 5 are present. The server 5 may be present in a cloud or may be present in a company.

By using, as training data, the image data group in which the target person appears and which is included in the public data 51, or an image data group in which the target person appears and which is illegally recorded by an attacker, the information processing apparatus 3 generates a moving image for spoofing the target person by using the deep learning method of artificial intelligence. For example, the information processing apparatus 3 generates a deepfake that is a fake moving image of the target person. The information processing apparatus 3 causes the moving image data (deepfake) of the target person for spoofing the target person to be displayed on the information processing apparatus 2 on the attack target person side.

Upon detecting a suspicion of spoofing the target person, by a report from the attack target person for example, the detection apparatus 1 identifies a behavior having a low frequency of appearance in the past by using an image data group in which the target person appears and which is included in the public data 51, or an image data group in which the target person appears and which is not included in the public data 51 but may be recorded. In a case of determining that there is the suspicion of spoofing, the detection apparatus 1 outputs a message prompting the identified behavior to the information processing apparatus 3 on the attacker side suspected of spoofing the target person. Accordingly, the detection apparatus 1 may bring the image to a quality reduced state in which it is easier to identify spoofing in the case of spoofing using a machine learning method, by prompting the attacker to take the behavior with a low frequency of appearance in the past. As a result, the detection apparatus 1 may detect the spoofing.

Hereinafter, the detection apparatus 1 will be described in detail.

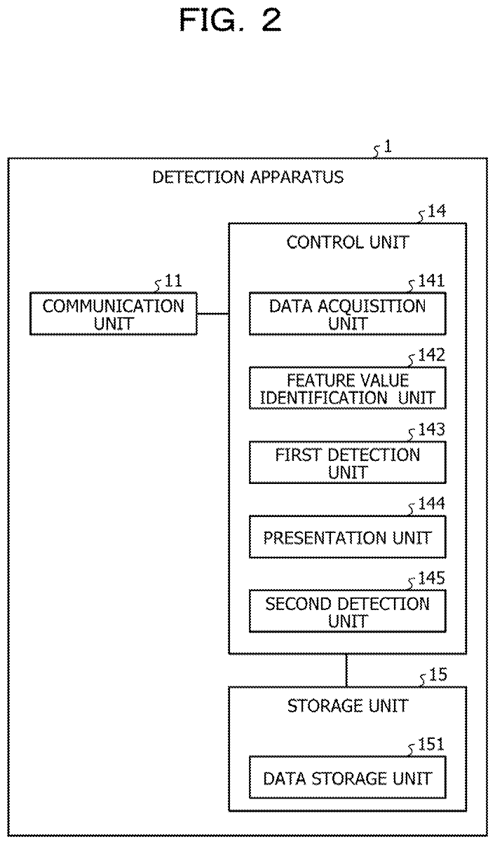

FIG. 2 is a diagram illustrating an example of a functional configuration of the detection apparatus according to the embodiment. As illustrated in FIG. 2, the detection apparatus 1 includes a communication unit 11, a control unit 14, and a storage unit 15.

The communication unit 11 communicates with the information processing apparatuses 2 and 3, the server 5, and the like via the network 7 (see FIG. 1). For example, the communication unit 11 is implemented by a network interface card (NIC) or the like.

The control unit 14 includes a data acquisition unit 141, a feature value identification unit 142, a first detection unit 143, a presentation unit 144, and a second detection unit 145. The data acquisition unit 141 is an example of an acquisition unit. The feature value identification unit 142 is an example of an identification unit. The first detection unit 143 and the presentation unit 144 are an example of an output unit.

The storage unit 15 includes a data storage unit 151. The data storage unit 151 stores a past image data group in which the target person to be spoofed appears. The image data group includes moving image data and still image data. Some moving image data includes audio data. In the data storage unit 151, the past image data group is stored by the data acquisition unit 141.

The data acquisition unit 141 acquires the image data group in which the target person to be spoofed appears from the public data 51. For example, the data acquisition unit 141 may operate at a timing at which the suspicion of spoofing is detected by the first detection unit 143 to be described later.

By using the image data group, the feature value identification unit 142 identifies a feature value having the lowest frequency of appearance. For example, by using the image data group, the feature value identification unit 142 identifies a first behavior of the target person to be spoofed such that a frequency of appearance of the first behavior is lower than a frequency of appearance of a second behavior. The behavior referred to herein is represented by a feature value for a feature. For example, by using the image data group acquired by the data acquisition unit 141, the feature value identification unit 142 extracts a feature value for a predetermined feature to be used to identify a person. The feature value identification unit 142 generates a distribution of frequencies of appearance of each extracted feature value (behavior). From the distribution of frequencies of appearance, the feature value identification unit 142 identifies, as the first behavior, a feature value of the target person to be spoofed that has the lowest frequency of appearance. Examples of the predetermined feature to be used to identify the person include, but are not limited to, a facial direction, the rhythm of voice, an uttered word, and an uttered phoneme. For example, which features are to be used may be defined in the storage unit 20 in advance.

The feature value identification unit 142 may extract the feature value for the predetermined feature as follows. For example, in a case where the predetermined feature is the facial direction (head pose), the feature value identification unit 142 detects the face of the target person to be spoofed from the image data group. The feature value identification unit 142 acquires landmarks (feature points) of the detected face. The feature value identification unit 142 calculates an angle of the face by using a Perspective-n-Point algorithm or supervised learning by using the acquired feature points. In a case where the Perspective-n-Point algorithm is used, the feature value identification unit 142 may calculate the angle of the face as the feature value from a calculated rotation matrix of a camera. For the estimation of the facial direction (head pose), Microsoft Asure Face (trademark) Application Programming Interface (API), Amazon Rekognition (trademark) API, Google Cloud Vision API, or Head-Pose-Estimation may also be used.

In a case where the predetermined feature is the rhythm of voice (a phonetic property appearing in an utterance), the feature value identification unit 142 extracts a feature value from an image data group including voice. As an example, the feature value identification unit 142 detects, as the feature value, a peak of a spectrum envelope extracted by performing waveform prediction encoding on a speech waveform by using a waveform envelope method. As another example, the feature value identification unit 142 detects, as the feature value, a peak of an autocorrelation function of the speech waveform by using an autocorrelation method. As still another example, the feature value identification unit 142 detects, as the feature value, a quefrency component having a high cepstrum (obtained by performing Fourier transform on an amplitude spectrum) of voice.

In a case where the predetermined feature is the uttered word, the feature value identification unit 142 performs voice recognition from voice and converts the voice into text (utterance content). The feature value identification unit 142 performs word segmentation on the converted text and extracts each word as the feature value.

In a case where the predetermined feature is the uttered phoneme, the feature value identification unit 142 performs voice recognition from voice and converts the voice into text (utterance content). The feature value identification unit 142 divides the converted text into phonemes. The feature value identification unit 142 extracts each phoneme as the feature value.

The first detection unit 143 simply detects the suspicion of spoofing. For example, the first detection unit 143 simply detects that there is the suspicion of spoofing in the image data which is displayed on the information processing apparatus 2 and in which the target person to be spoofed appears.

For example, the first detection unit 143 may detect the suspicion of spoofing the target person by using any past technique. As an example, the first detection unit 143 may use a technique of determining that there is spoofing when the same behavior at present is not similar to any of one or more past behaviors by using the image data group acquired by the data acquisition unit 141. Such a technique is, for example, the technique described in Japanese Patent No. 6901190.

In another example, the first detection unit 143 may detect the suspicion of spoofing the target person by a notification by the attack target person viewing a screen of the information processing apparatus 2. As an example, a button may be displayed on the screen of the information processing apparatus 2. When the attack target person who is viewing the screen of the information processing apparatus 2 presses the button upon determining that there is the suspicion of spoofing, the first detection unit 143 may detect the suspicion of spoofing the target person.

Upon the detection of the suspicion of spoofing, the presentation unit 144 outputs a message prompting the first behavior for the identified feature value, to the information processing apparatus 3 on the attacker side suspected of spoofing. For example, upon the detection of the suspicion of spoofing, the presentation unit 144 presents, to the target person appearing in the image data displayed on the information processing apparatus 2, a message prompting the target person to take the first behavior for the feature value identified by the feature value identification unit 142. For example, in a case where there is the suspicion of spoofing during remote interaction, the presentation unit 144 guides a person suspected of spoofing the target person to take the behavior for the feature value having the lowest frequency of appearance.

The second detection unit 145 detects spoofing. For example, the second detection unit 145 detects spoofing, based on a degree of distortion of the image data of the behavior taken in accordance with the presentation unit 144. For example, in the case of spoofing by the deepfake, the person suspected of the spoofing is caused to take the behavior having the lowest frequency of appearance in the past data, and thus, synthesis quality of the obtained image decreases. Accordingly, unnatural distortion of the image is likely to occur. As a result, the second detection unit 145 may detect the spoofing, based on a degree of the unnatural distortion of the image data. As an example, the second detection unit 145 detects spoofing, based on the deep learning method. In another example, the second detection unit 145 detects spoofing, based on determination by a person. Accordingly, it is possible to increase a possibility that the second detection unit 145 correctly detects the spoofing by the deepfake.

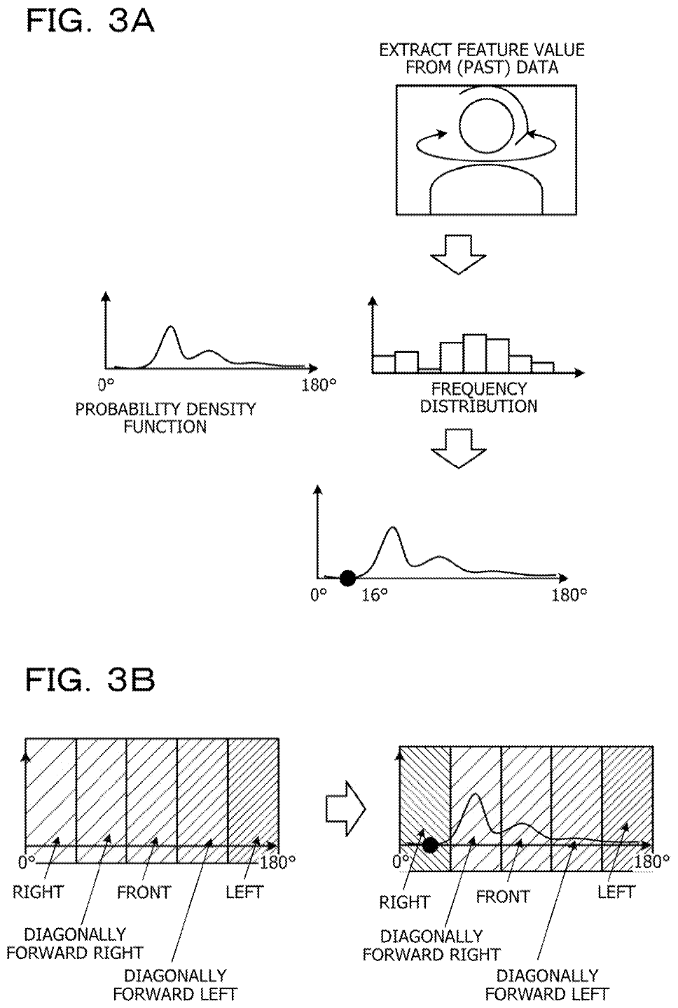

A flow of identifying the feature value according to the embodiment will be described with reference to FIGS. 3A and 3B. FIGS. 3A and 3B are diagrams illustrating an example of the flow of identifying the feature value according to the embodiment. In FIGS. 3A and 3B, it is assumed that the facial direction is defined as the feature.

As illustrated in FIG. 3A, the feature value identification unit 142 extracts a feature value for the facial direction from the past image data group. The feature value identification unit 142 generates a distribution of frequencies of appearance in each extracted feature value (behavior). A probability density function or a frequency distribution is used as the distribution of frequencies of appearance. For example, in a case where the feature value is a continuous value, a probability density function is suitably used. In a case where the feature value is a qualitative variable, a frequency distribution is suitably used. Since the feature value of the facial direction is a continuous value, it is assumed that a probability density function is used. At the bottom of FIG. 3A, a distribution of frequencies of appearance in each feature value of the facial direction is generated. From the generated distribution of frequencies of appearance, the feature value identification unit 142 identifies a feature value having the lowest frequency of appearance by using minimum search or the like.

As illustrated in a left diagram of FIG. 3B, the feature value identification unit 142 associates each feature value of the facial direction with a category of the behavior. The feature value identification unit 142 sorts the continuous-value feature values for the facial direction from 0° to 180° in 36° groups, and associates the feature values for each 36° group with a category of the behavior. The feature values “0° to 36° ” are associated with “right” as the category of the behavior. The feature values “36° to 72° ” are associated with “diagonally forward right” as the category of the behavior. The feature values “72° to 108° ” are associated with “front” as the category of the behavior. The feature values “108° to 144° ” are associated with “diagonally forward left” as the category of the behavior. The feature values “144° to 180° ” are associated with “left” as the category of the behavior.

As illustrated in a right diagram of FIG. 3B, the feature value identification unit 142 identifies the category of the behavior for the identified feature value having the lowest frequency of appearance, based on the association between the feature value and the category of the behavior. Since a frequency of appearance of the facial direction of “0° to 36° ” is the lowest, “right” for the facial direction of “0° to 36° ” is identified as the first behavior. Thereafter, upon detection of the suspicion of spoofing, the presentation unit 144 presents a message prompting the target person appearing in the image data displayed on the information processing apparatus 2 to turn the face to “right”, for example.

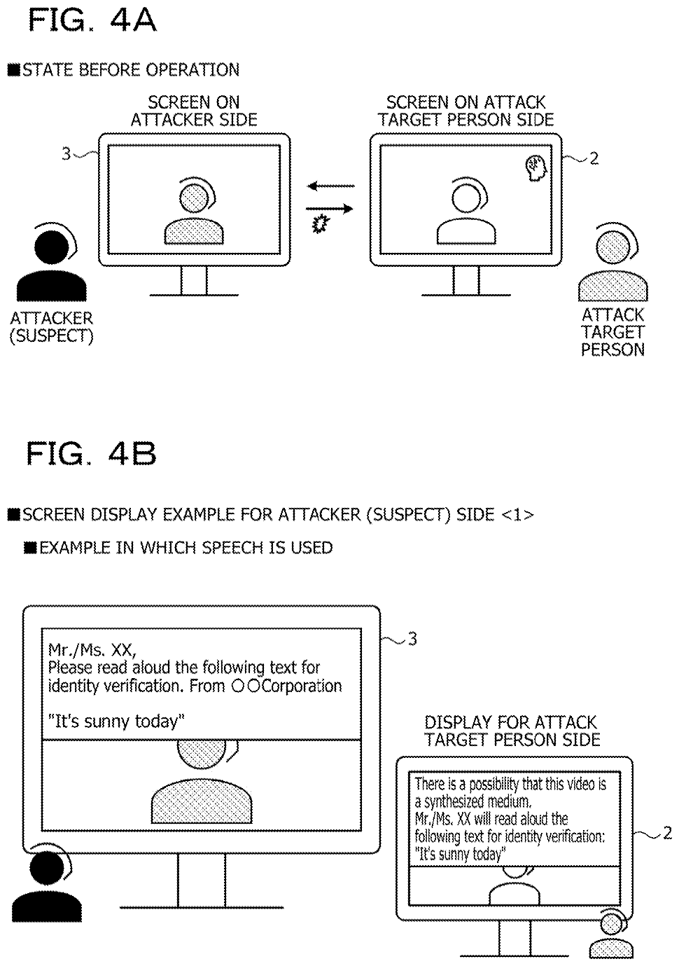

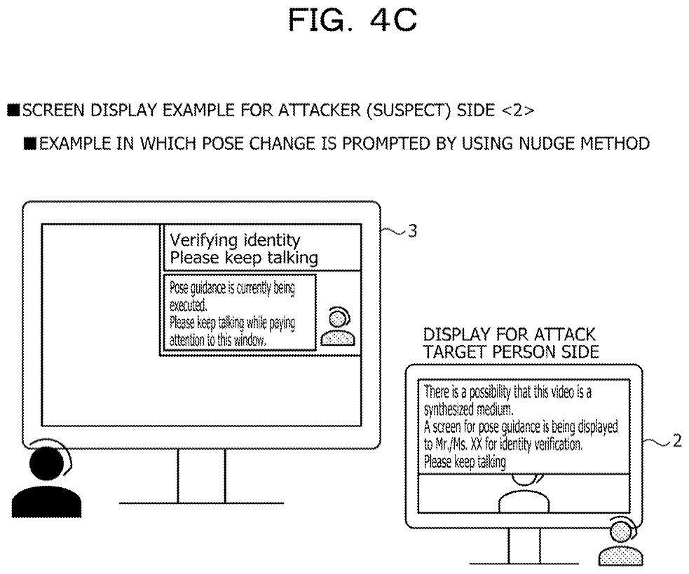

An image of the presentation according to the embodiment will now be described with reference to FIGS. 4A to 4C. FIGS. 4A to 4C are image diagrams of the presentation according to the embodiment. In FIGS. 4A to 4C, it is assumed that the attacker side and the attack target person side perform a teleconference. In FIG. 4A, the image data of the attack target person is displayed on a screen of the information processing apparatus 3 on the attacker side, and the image data of the target person to be spoofed is displayed on the screen of the information processing apparatus 2 on the attack target person side. The image data of the target person to be spoofed is a deepfake generated by using the deep learning method of artificial intelligence. It is assumed that the first detection unit 143 simply detects the suspicion of spoofing.

The presentation unit 144 presents a message prompting the target person appearing in the image data displayed on the information processing apparatus 2 to take the first behavior. For example, the presentation unit 144 outputs a message prompting the first behavior to the information processing apparatus 3 on the attacker side suspected of spoofing.

In FIG. 4B, it is assumed that the feature defined by the feature value identification unit 142 is “speech” (uttered word). It is assumed that the first behavior identified by the feature value identification unit 142 is “It's sunny today”. For example, it is assumed that the speech “It's sunny today” is identified as a speech having the lowest frequency of appearance among speeches uttered in the past.

As illustrated in FIG. 4B, “Mr./Ms. XX, Please read aloud the following text for identity verification.” and “It's sunny today” are displayed on the screen on the attacker side of the information processing apparatus 3. For example, upon detection of a suspicion of spoofing on one party during remote interaction, the presentation unit 144 guides the one party to read aloud a speech (uttered word) having the lowest frequency of appearance among speeches in the past data. On the screen on the attack target person side of the information processing apparatus 2, “There is a possibility that this video is a synthesized medium. Mr./Ms. XX will read aloud the following text for identity verification.” and “It's sunny today” are displayed.

In FIG. 4C, it is assumed that the feature defined by the feature value identification unit 142 is “pose”. It is assumed that the first behavior identified by the feature value identification unit 142 is “nnn”. For example, it is assumed that the pose “nnn” is identified as a pose having the lowest frequency of appearance among past poses.

As illustrated in FIG. 4C, “Verifying identity Please keep talking” and “Pose guidance is currently being executed. Please keep talking while paying attention to this window” are displayed on the screen on the attacker side of the information processing apparatus 3. For example, upon detecting a suspicion of spoofing on one party during remote interaction, the presentation unit 144 guides the one party to change the pose to a pose having the lowest frequency of appearance among poses in the past data. On the screen on the attack target person side of the information processing apparatus 2, “There is a possibility that this video is a synthesized medium. A screen for pose guidance is being displayed to Mr./Ms. XX for identity verification. Please keep talking.” is displayed.

The second detection unit 145 detects spoofing, based on a degree of unnatural distortion of the image data of the behavior taken in accordance with the presentation unit 144. As an example, the second detection unit 145 detects spoofing, based on the deep learning method. In another example, the second detection unit 145 detects spoofing, based on the determination of the attack target person. Accordingly, it is possible to increase a possibility that the second detection unit 145 correctly detects the spoofing by the deepfake.

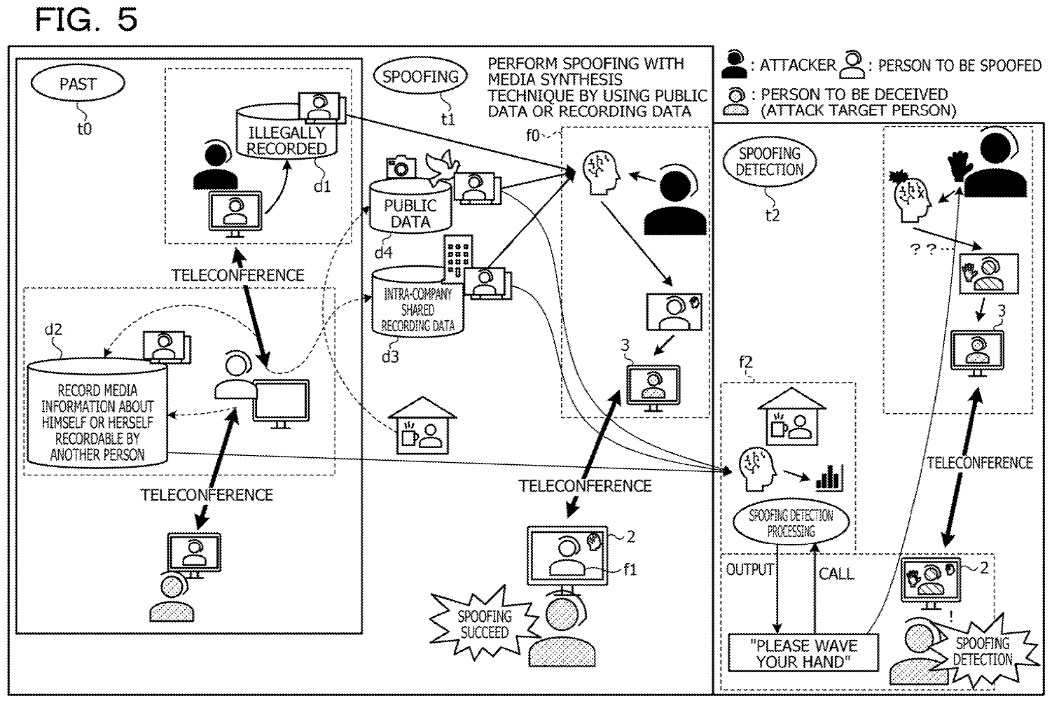

FIG. 5 is a diagram illustrating an example of an application of the spoofing detection according to the embodiment. In FIG. 5, the person to be spoofed (target person) is represented by a white person mark. The attacker is represented by a black person mark. The person to be deceived (attack target person) is represented by a dotted gray person mark. As illustrated in FIG. 5, in the past (t0), the person to be spoofed (target person) performs a teleconference with people including the attacker. The attacker illegally records an image data group in which the target person appears in the teleconference (d2). The target person records media information about himself or herself (d2), and records, for example, intra-company shared recording data d3. Public data d4 is a past image data group in which the target person appears and is an image data group that is made public.

Under such a situation, the attacker spoofs the target person (t1). The attacker generates image data spoofing the target person with a media synthesis technique by using the public data d4, the intra-company shared recording data d3, and the illegally recorded recording data d1 (f0). For example, the attacker generates a deepfake of the target person. The attacker performs a teleconference with the attack target person of the information processing apparatus 2 by using the image data (f1) for spoofing the target person.

In spoofing detection (t2), upon detecting a suspicion of spoofing the target person with regard to the image data displayed by the information processing apparatus 2 in spoofing detection processing, a behavior corresponding to a feature value having the lowest frequency of appearance is identified by using the public data d4, the intra-company shared recording data d3, and the recording data of the target person that may be recorded. In the spoofing detection processing, a message prompting the identified behavior is output to the information processing apparatus 3 on the attacker side suspected of spoofing. It is assumed that a feature value of waving a hand is a feature value having the lowest frequency of appearance. Accordingly, in the spoofing detection processing, a message “Please wave your hand” is output.

On the attacker side, according to an instruction of the output message, the image data spoofing the target person is operated by using the media synthesis technique. In the spoofing detection processing, spoofing is detected based on a degree of unnatural distortion of the image data operated in accordance with the message. For example, in the case of spoofing by the deepfake, the person suspected of the spoofing is caused to take the behavior having the lowest frequency of appearance in the past data, and thus, synthesis quality of the obtained image reduces. Accordingly, unnatural distortion of the image is likely to occur. As a result, it is possible to increase a possibility that the spoofing detection processing correctly detects the spoofing by the deepfake.

### Entire Flowchart

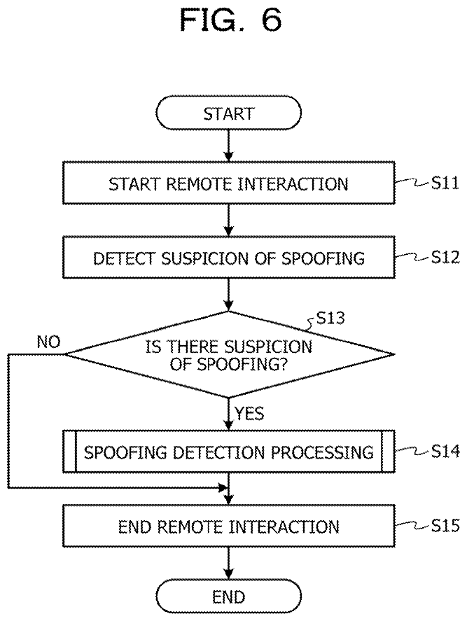

FIG. 6 is a diagram illustrating an example of a flowchart of the entire spoofing detection according to the embodiment. As illustrated in FIG. 6 (with reference to FIG. 2), upon accepting the start of remote interaction, the control unit 14 of the detection apparatus 1 starts the remote interaction (step S11). For example, the control unit 14 starts the remote interaction between the information processing apparatus 2 and the information processing apparatus 3.

During the interaction, the first detection unit 143 detects a suspicion of spoofing (step S12). For example, the first detection unit 143 simply detects that the image data in which the target person to be spoofed appears and which is displayed on the information processing apparatus 2, has the suspicion of spoofing. For example, the first detection unit 143 simply detects that there is the suspicion of spoofing by accepting a notification indicating that there is the suspicion of spoofing from the information processing apparatus 2.

The first detection unit 143 determines whether or not there is the suspicion of spoofing (step S13). In a case where it is determined that there is no suspicion of spoofing (step S13; No), the control unit 14 proceeds to step S15 explained below.

On the other hand, in a case where it is determined that there is the suspicion of spoofing (step S13; Yes), the control unit 14 executes the spoofing detection processing (step S14). A flowchart of the spoofing detection processing will be described later. The control unit 14 then proceeds to step S15.

In step S15, upon accepting the end of the remote interaction, the control unit 14 ends the remote interaction (step S15). For example, the control unit 14 ends the remote interaction between the information processing apparatus 2 and the information processing apparatus 3.

### Flowchart of Spoofing Detection Processing

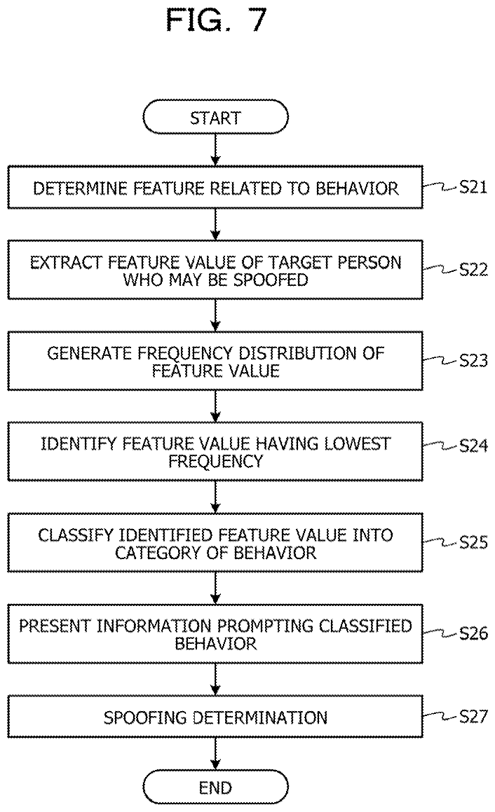

FIG. 7 is a diagram illustrating an example of a flowchart of the spoofing detection processing according to the embodiment.

As illustrated in FIG. 7 (with reference to FIG. 2), the feature value identification unit 142 determines a feature related to a behavior (step S21). Such a feature may be stored in the storage unit 15 in advance.

The feature value identification unit 142 extracts a feature value for the determined feature of the target person who may be spoofed (step S22). For example, the data acquisition unit 141 acquires, from the public data 51, an image data group in which the target person who may be spoofed appears. The feature value identification unit 142 extracts the feature value for the determined feature from the image data group acquired by the data acquisition unit 141.

The feature value identification unit 142 generates a frequency distribution of the extracted feature value (step S23). The feature value identification unit 142 identifies a feature value having the lowest frequency of appearance (step S24). The feature value identification unit 142 classifies the identified feature value into the category of the behavior (step S25).

The presentation unit 144 presents information prompting the classified behavior, to a person suspected of spoofing the target person (step S26). For example, the presentation unit 144 presents a message prompting the classified behavior, to the information processing apparatus 3 on the attacker side suspected of spoofing the target person.

The second detection unit 145 determines spoofing (step S27). For example, the second detection unit 145 detects spoofing, based on a degree of unnatural distortion of the image data of the behavior taken in accordance with the presentation. The second detection unit 145 ends the spoofing detection processing.

### Effects of Embodiment

According to the above-described embodiment, the detection apparatus 1 acquires an image data group in which a target person appears from the data storage unit. By using the acquired image data group, the detection apparatus 1 identifies a first behavior, of the target person, of which the frequency of appearance is lower than a frequency of appearance of a second behavior. When it is detected that the image data in which the target person appears and which is displayed on a screen, has a suspicion of spoofing, the detection apparatus 1 outputs a message prompting the target person appearing in the image data to take the identified first behavior. According to such a configuration, in a case where the image data in which the target person appears is the deepfake, the detection apparatus 1 may detect the spoofing by the deepfake. For example, the detection apparatus 1 may prompt an action that makes a behavior in fake image data unnatural, and may cause a person to visually determine the fake.

According to the above-described embodiment, the detection apparatus 1 extracts a plurality of feature values for a predetermined feature to be used for identifying the person, by using the image data group. The detection apparatus 1 generates a distribution of frequencies of appearance in each of the plurality of extracted feature values. From the distribution of frequencies of appearance, the detection apparatus 1 identifies, as the first behavior, a behavior corresponding to a feature value having the lowest frequency of appearance. According to such a configuration, the detection apparatus 1 may identify a behavior that makes generation accuracy of the deepfake low, by using the frequency of appearance of the feature value corresponding to the behavior.

According to the above-described embodiment, the detection apparatus 1 detects spoofing of the target person, based on a degree of unnatural distortion of image data obtained as a result of the first behavior being taken by the target person suspected of spoofing. According to such a configuration, the detection apparatus 1 may determine that the image data is fake by using the degree of unnatural distortion of the image data. The detection apparatus 1 may cause the person to visually determine the fake.

### Others

According to the embodiment, it has been described that, upon detecting the suspicion of spoofing the target person, the detection apparatus 1 performs the spoofing detection processing of identifying the behavior having the low frequency of appearance by using the past image data group in which the target person appears and of outputting the message prompting the identified behavior. However, the spoofing detection processing is not limited to this, and the spoofing detection processing may be installed in the information processing apparatuses 2 and 3 that perform a teleconference, and the information processing apparatuses 2 and 3 may perform the spoofing detection processing.

According to the embodiment, it has been described that the feature value identification unit 142 identifies, as the first behavior, the feature value of the spoofed target person, which is the feature value having the lowest frequency of appearance in the feature value for the predetermined feature to be used for identifying the person. The presentation unit 144 presents, to the information processing apparatus 3 on the attacker side suspected of spoofing, the message prompting the first behavior for the identified feature value. However, the feature value identification unit 142 may have a plurality of predetermined features instead of one predetermined feature, and may identify, as the first behavior, each feature value for the plurality of features. The presentation unit 144 presents, to the information processing apparatus 3 on the attacker side suspected of spoofing, the message prompting the first behavior for each of the identified feature values. Accordingly, the presentation unit 144 may detect the spoofing by the deepfake with higher accuracy, by prompting the behaviors for the plurality of features.

In the above-described embodiment, each constituent component of the illustrated detection apparatus 1 may not be physically constituted as illustrated. For example, a specific form of separation or integration of the detection apparatus 1 is not limited to the illustrated form, and all or some of the apparatus may be constituted to be functionally or physically separated or integrated in arbitrary units depending on various loads, usage states, and the like. For example, the data acquisition unit 141 and the feature value identification unit 142 may be integrated. The storage unit that stores the data storage unit 151 and the like may be coupled via a network as an external device of the detection apparatus 1.

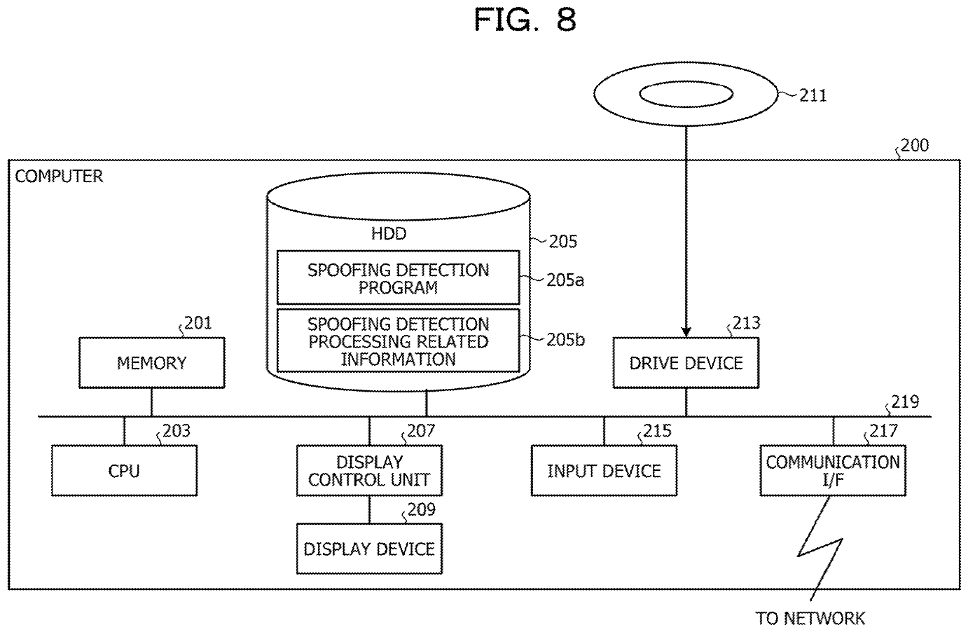

Various kinds of processing described in the above-described embodiment may be implemented by executing a program prepared in advance on a computer, such as a personal computer or a workstation. An example of a computer that executes a spoofing detection program for implementing functions similar to the functions of the detection apparatus 1 illustrated in FIG. 2 will be described below. FIG. 8 is a diagram illustrating an example of the computer that executes the spoofing detection program.

As illustrated in FIG. 8, a computer 200 includes a central processing unit (CPU) 203 that executes various kinds of arithmetic processing, an input device 215 that accepts an input of data from a user, and a display device 209. The computer 200 also includes a drive device 213 that reads a program or the like from a storage medium, and a communication interface (I/F) 217 that exchanges data with another computer via a network. The computer 200 also includes a memory 201 that temporarily stores various kinds of information and a hard disk drive (HDD) 205. The memory 201, the CPU 203, the HDD 205, a display control unit 207, the display device 209, the drive device 213, the input device 215, and the communication I/F 217 are coupled to each other by a bus 219.

The drive device 213 is, for example, a device for a removable disc 211. The HDD 205 stores a spoofing detection program 205a and spoofing detection processing related information 205b. The communication I/F 217 serves as an interface between the network and an inside of the apparatus, and controls an input and an output of data from and to another computer. For example, a modem, a LAN adapter, or the like may be employed as the communication I/F 217.

The display device 209 is a display device that displays a cursor, an icon, a toolbox, and data such as a document, an image, and function information. For example, a liquid crystal display, an organic electroluminescence (EL) display, or the like may be employed as the display device 209.

The CPU 203 reads out the spoofing detection program 205a, loads the program in the memory 201, and executes the program as a process. Such a process corresponds to each functional unit of the detection apparatus 1. Examples of the spoofing detection processing related information 205b include the data storage unit 151. For example, the removable disc 211 stores each information such as the spoofing detection program 205a.

The spoofing detection program 205a may not be stored in the HDD 205 from the beginning. For example, the program may be stored in a “portable physical media” such as a flexible disk (FD), a compact disk read-only memory (CD-ROM), a Digital Versatile Disc (DVD), a magneto-optical disk, or an integrated circuit (IC) card to be inserted into the computer 200. The computer 200 may read out and execute the spoofing detection program 205a from such a medium.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
acquiring an image data group, in which a target person appears, from a storage unit;
identifying a first behavior of the target person, of which a frequency of appearance is lower than a frequency of appearance of a second behavior by using the acquired image data group; and
when it is detected that image data, in which the target person appears and which is displayed on a screen, has a suspicion of spoofing, outputting a message prompting the target person appearing in image data to take the identified first behavior.

2. The non-transitory computer-readable recording medium according to claim 1, the process further comprising:
extracting a plurality of feature values for a predetermined feature to be used to identify a person by using the image data group;
generating a distribution of frequencies of appearance in each of the plurality of extracted feature values, and
identifying, as the first behavior, a behavior corresponding to a feature value having a lowest frequency of appearance from the distribution of frequencies of appearance.

3. The non-transitory computer-readable recording medium according to claim 1, the process further comprising:
detecting spoofing of the target person based on a degree of predefined unnatural distortion of image data obtained as a result of the first behavior being taken by the target person suspected of spoofing.

4. The non-transitory computer-readable recording medium according to claim 2, wherein
the predetermined feature includes any one of a facial direction, rhythm of voice, an uttered word, and an uttered phoneme.

5. A detection apparatus, comprising:
a memory; and
a processor coupled to the memory and the processor configured to:
acquire an image data group in which a target person appears from a storage unit;
identify a first behavior of the target person, of which a frequency of appearance is lower than a frequency of appearance of a second behavior by using the acquired image data group; and
when it is detected that image data, in which the target person appears and which is displayed on a screen, has a suspicion of spoofing, output a message prompting the target person appearing in image data to take the identified first behavior.

6. A spoofing detection method, comprising:
acquiring, by a computer, an image data group in which a target person appears from a storage unit;
identifying a first behavior of the target person, of which a frequency of appearance is lower than a frequency of appearance of a second behavior by using the acquired image data group; and
when it is detected that image data, in which the target person appears and which is displayed on a screen, has a suspicion of spoofing, outputting a message prompting the target person appearing in image data to take the identified first behavior.
